(19) United States
(12) Patent Application Publication
(10) Pub. No.: US 2007/0071915 A1
(43) Pub. Date: Mar. 29, 2007

(54) Decorative bow

(76) Inventor: Charles J. Sven, Antioch, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/236,241

(22) Filed: Sep. 27, 2005

(51) Int. Cl. B32B 3/00

(52) U.S. Cl. 428/4; 428/12; 156/63; 156/92

(57) ABSTRACT

A decorative bow and method of making a decorative bow is provided. The decorative bow comprises a plurality of vertically stacked sheets of material and a base. Each of the plurality of sheets comprising a top surface, a bottom surface, and a plurality of contiguous curvilinear petals. The petals of each sheet are disposed in an alternating curvilinear direction with respect to the petals of each adjacent sheet, and at least some of the petals of each sheet are interleaved with at least some of the petals of an adjacent sheet. The base is attached to the bottom surface of the bottom-most sheet of the plurality of vertically stacked sheets of material. According to one aspect of the present invention, at least some of the plurality of sheets of material are circular in dimension and shape.

### CROSS-REFERENCE TO RELATED APPLICATIONS

### TECHNICAL FIELD

The invention relates to decorative adornment for gift packages and the like, and more particularly to a bow and method for making the same.

### BACKGROUND OF THE INVENTION

Various decorative bows are available for adorning gift packages, walls, and other surfaces. Such bows typically consist of ribbon or similar materials configured as a multitude of interwoven loops. While such bows have enjoyed a degree of success, there still exist several disadvantages to their form. For example, known bows are difficult to ship because of their configuration. Thus, transport often results in crushing or otherwise damaging the bow.

Other bow configurations, such as those shown in U.S. Pat. No. 6,074,712 to Ramirez do not maintain a fluffed shape once the material comprising the bows is compressed. Bows such as those shown in U.S. Pat. No. 1,003,895 to Gasthoff do not resist compression unless the petals are crinkled. In particular, the radially projecting petals of Gastoff do not prevent petals of adjacent sheets from collapsing after extended periods of use.

The present invention is provided to solve this and other problems, and to provide advantages and aspects not provided by prior bows. A full discussion of the features and advantages of the present invention is deferred to the following detailed description, which proceeds with reference to the accompanying drawings.

### SUMMARY OF THE INVENTION

According to the present invention, a decorative bow is provided. The decorative bow comprises a plurality of vertically stacked sheets of material and a base. Each of the plurality of sheets has a top surface, a bottom surface, and a plurality of contiguous curvilinear petals. The petals of each sheet are disposed in an alternating curvilinear direction with respect to the petals of each adjacent sheet, and at least some of the petals of each sheet are interleaved with at least some of the petals of an adjacent sheet. The base is attached to the bottom surface of the bottom-most sheet of the plurality of vertically stacked sheets of material. According to one aspect of the present invention, at least some of the plurality of sheets of material are circular in dimension and shape.

According to another aspect of the present invention, the base further comprises a top and a bottom surface. According to such an embodiment, the bottom surface of the base comprises an adhesive material.

According to yet another aspect of the present invention, a decorative bow is provided that comprises a plurality of vertically stacked sheets of material and a base. Each of the plurality of sheets has a top surface, a bottom surface, and a plurality of contiguous curvilinear petals. The petals of each sheet are disposed in an alternating curvilinear direction with respect to the petals of each adjacent sheet, and at least some of the petals of each sheet are interleaved with at least some of the petals of an adjacent sheet of material. The base is attached to the bottom surface of the bottom-most sheet of the plurality of vertically stacked sheets of material. The base is comprised of a bottom wall defining a perimeter, at least one sidewall appending upwardly from the perimeter of the bottom wall, an inner surface and an outer surface.

According to still another aspect of the present invention, the decorative bow also has an attaching sheet attached to the outer surface of the bottom wall of the base. The attaching sheet comprises a top surface and a bottom surface, and at least a portion of the bottom surface of the attaching sheet is an adhesive material.

According to still another aspect of the present invention, a method of assembling a decorative bow is provided. According to the method, a plurality of sheets of material is provide. Each sheet has a top surface and a bottom surface and comprises a plurality of contiguous curvilinear petals. Each of the sheets is vertically arranged such that the petals of each sheet are disposed in an alternating curvilinear direction with respect to the petals of each adjacent sheet. At least some of the plurality of petals of each sheet are interleaved with at least some of the plurality of petals of an adjacent sheet. The sheets of material are attached one to another, and the interleaved petals are fluffed to form the shape of the bow.

According to yet another aspect of the present invention, each of the plurality of sheets are attached to an adjacent sheet before the interleaving step.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a top perspective view of a decorative bow according to the present invention;

FIG. 2 is a bottom perspective view of the decorative bow shown in FIG. 1;

FIG. 3 is an exploded view of the components of the decorative bow shown in FIG. 1;

FIG. 4 is a perspective view of another embodiment of a decorative bow according to the present invention;

FIG. 5 is a bottom perspective view of the decorative bow shown in FIG. 4;

FIG. 6 is an exploded view of the components of the decorative bow shown in FIG. 4; and,

FIG. 7 is a top view of a blank used in connection with a decorative bow of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention generally relates to a decorative bow 1 for use with gift wrapping and the like. The decorative bow 1 of the present invention differs from prior bows in that the present decorative bow I employs interleaved or interlocking petals 18 as opposed to interwoven loops employed in prior bows.

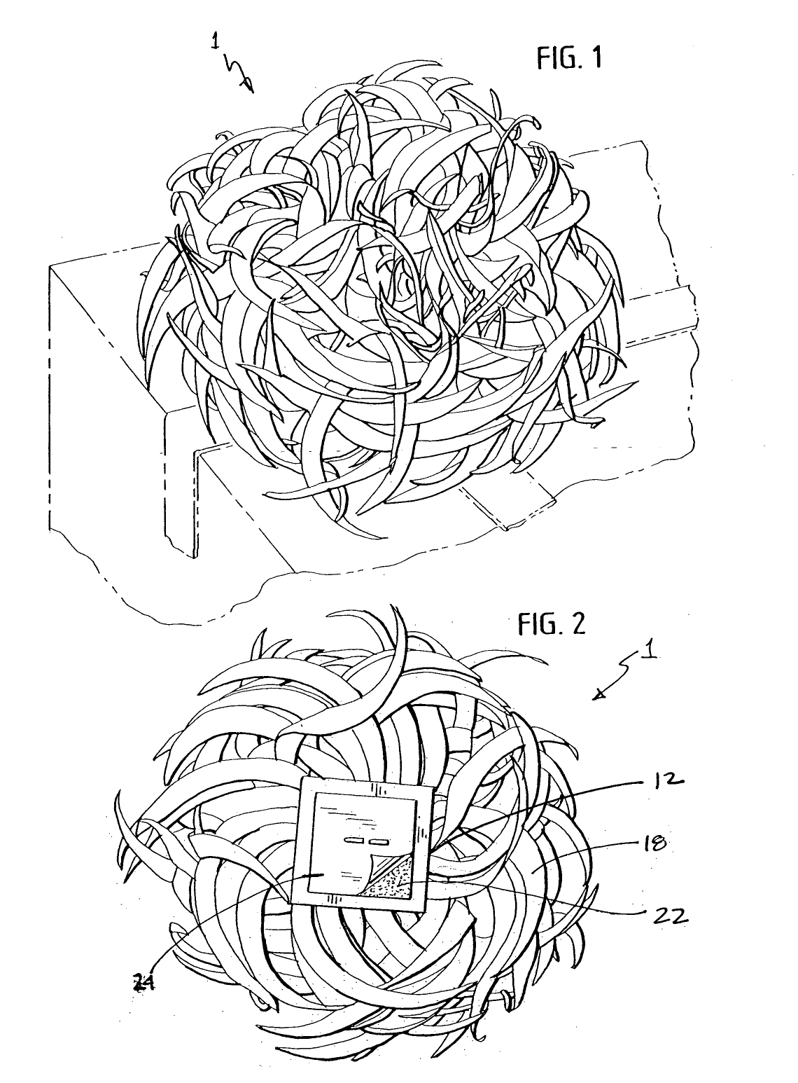

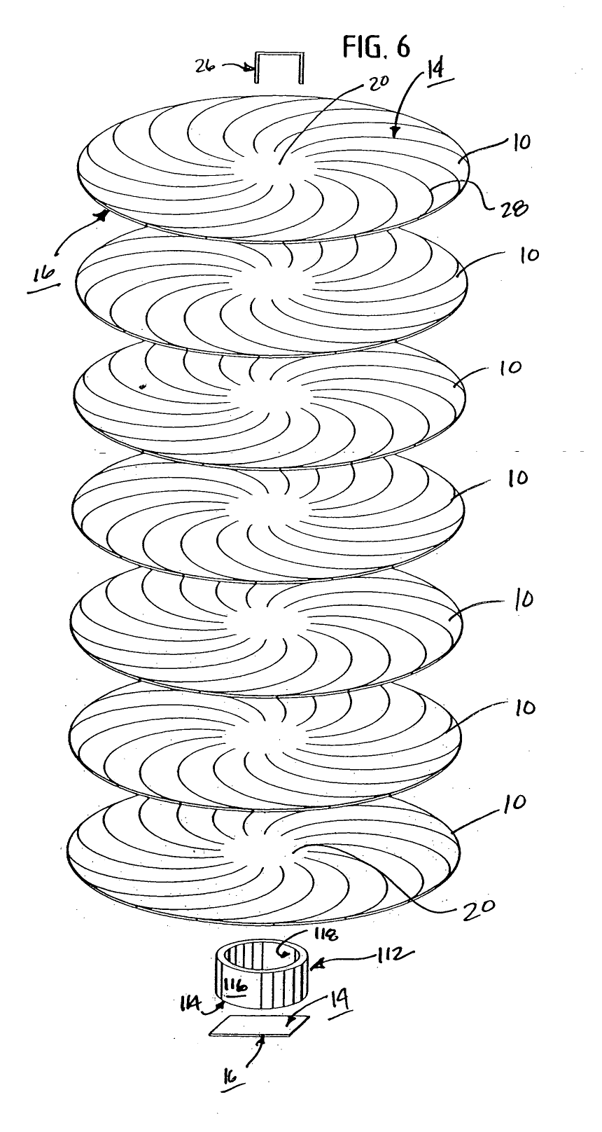

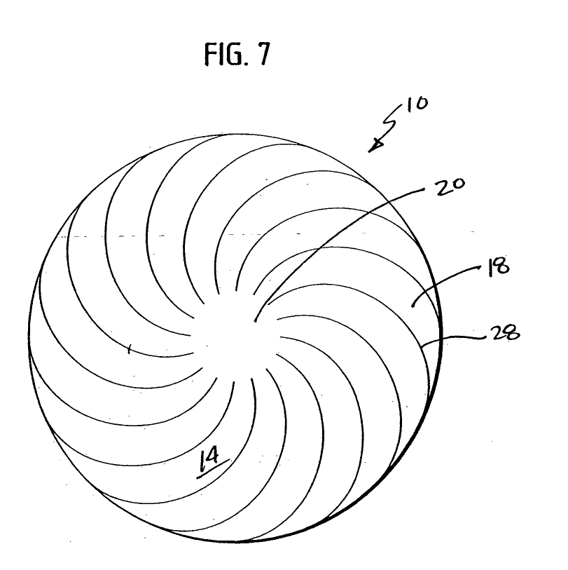

Referring now to FIGS. 1-7, the decorative bow 1 generally comprises a plurality of sheets of material 10 and a base 12. Each of the sheets of material 10 has a top surface 14, a bottom surface 16, and a plurality of contiguous curvilinear petals 18 formed thereon. In one embodiment of the invention in which the sheets 10 are generally circular in shape, the curvilinear petals 18 are generally configured as immediately adjacently positioned arcs or scimitars that extend outwardly from a center portion 20 of each of the sheets 10. It should be noted, however, that while the scimitar shape defines one embodiment of the invention, the petals 18 may conform to any curvilinear pattern without departing from the present invention. One of skill in the art would also understand that the geometric configuration of each sheet of material 10 may be any suitable shape. For example, the sheets 10 can be rectangular, polygonal or triangular in shape.

Referring to FIGS. 1-6, each of the sheets of material 10 are vertically stacked to form the body of the bow 1. More particularly, the sheets 10 are positioned so that the petals 18 of each sheet are disposed in an alternating curvilinear direction with respect to the petals 18 of each adjacent sheet. Thus, as may be seen in FIG. 1, a first sheet may be disposed such that the petals 18 radiate outwardly from the center portion 20 in a generally clockwise direction, and an immediately adjacent sheet will be positioned above or below the first sheet in a manner such that the petals 18 of the second sheet radiate outwardly from the center portion 20 in a generally counter-clockwise direction. As shown, at-least some of the petals 18 of each sheet of material 10 are interleaved with the petals 18 of at least an immediately adjacent sheet of material 10. Although the embodiment depicted herein, shows that all of the petals 18 of each sheet are interleaved with those of an adjacent sheet, it is suitable that only at least some of petals 18 of adjacent sheets 10 be interleaved.

According to the present invention, the sheets of material 10 may be made from one of various materials suitable for forming a decorative bow 1. However, it is preferable that the chosen material have sufficient stiffness so that when the petals 18 are interleaved and fluffed, the bow 1 sufficiently maintains its form and resists flattening. Accordingly, the sheets of material 10 may be foil, Mylar, paper, plastic, fabric, foam, film, combinations of the foregoing or any other suitable material. It is also contemplated that the color of each sheet of material 10 be a different color than an adjacent sheet of material 10. It is further contemplated that the petals 18 may be fluted or otherwise crinkled to create a desired texture.

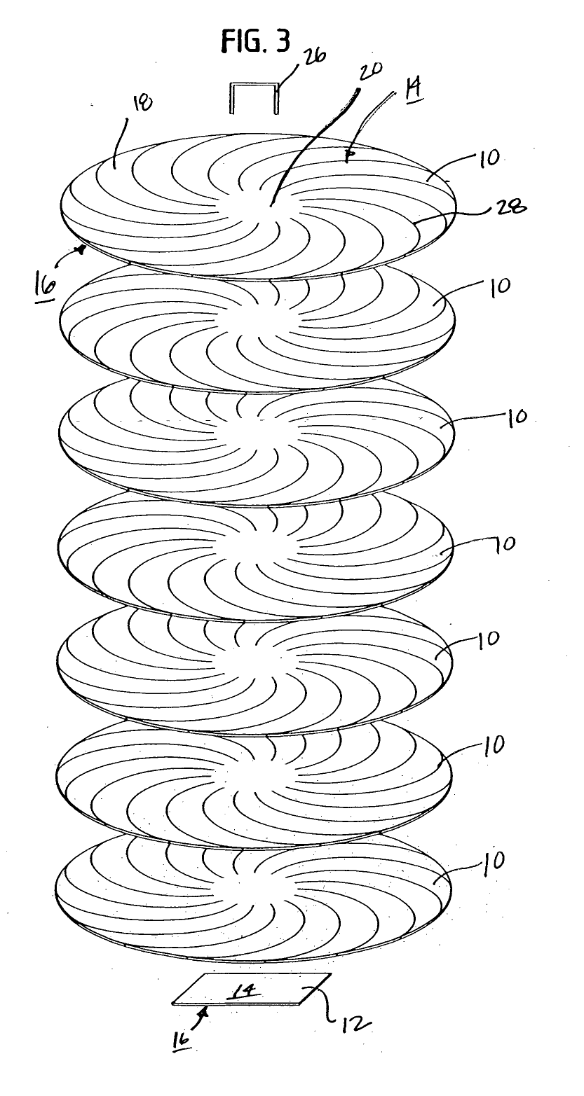

As discussed above, the bow 1 of the present invention also includes a base 12 attached to a center portion 20 of the bottom-most sheet of material 10. The base 12 of the present invention is used to attach the material component of the bow 1 to a package surface, wrapping paper, wall surface or the like. FIGS. 2 and 3 illustrate one embodiment of a base 12 that may be used. According to such an embodiment, the base 12 is a counter having a top surface 14 and a bottom surface 16. As shown in FIGS. 2 and 3, the base 12 is generally rectangular or square shaped. It is contemplated, however, that the counter be circular, or any other shape. It is preferable that the counter be formed from a material such as cardboard, plastic or a heavy paperboard stock to provide additional stability for the material defining the body of the bow 1. However, any suitable material may be employed without departing from the present invention.

The bottom surface 16 of the base 12 defines an attaching layer 22, wherein at least a portion of the attaching layer 22 is an adhesive material. In particular, the attaching layer 22 is preferably a single or double sided adhesive covered by a removable backing 24 that, when peeled away, exposes the adhesive portion. The adhesive is of the type suitable to temporarily or permanently attach the bow 1 to a package surface, wrapping paper or other surface (e.g., a hat, clothing, etc.).

In one embodiment of the present invention, the bottom surface 16 of the bottom-most sheet 10 of material constitutes the base 12 and attaching layer 22 of the bow 1. According to such an embodiment, the bottom surface 16 of the bottom-most sheet of material 10 is itself an adhesive material, or has an adhesive applied thereto. As with the embodiment previously described, the bottom surface 16 of the bottom-most sheet of material 10 would preferably include a removable backing 24 covering the adhesive that could be peeled away when so desired.

It should be understood, that the construction of this embodiment of the present provides significant advantages over prior bows, particularly those consisting of interwoven loops of material. In particular, the embodiment of the invention shown in FIGS. 1-3, the bow may be shipped as a flat assembly prior the petals 18 being interleaved and fluffed. Accordingly, any damage to the ultimate shape of the bow 1 is minimized.

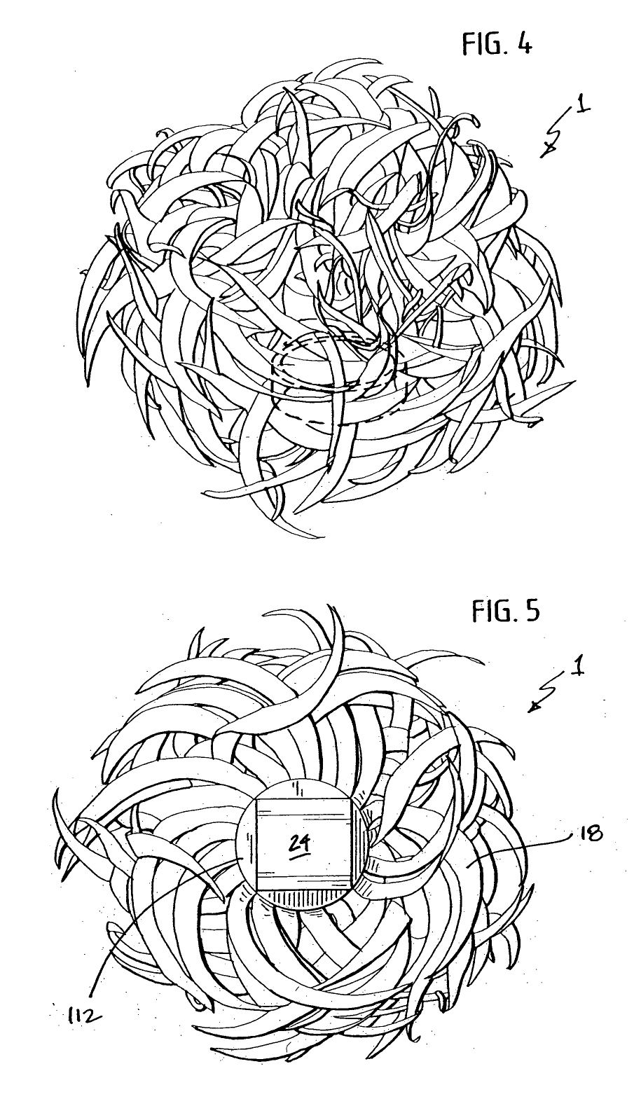

In another embodiment of the present invention shown in FIGS. 4-6, the base 112 is a cap member comprised of a bottom wall 114 defining a perimeter and a sidewall 116 appending upwardly from the perimeter of the bottom wall 114. The bottom wall 114 of the base 112 in this embodiment has an inner surface 118 and an outer surface 120. As shown in FIGS. 4-6, the center portions 20 of the sheets of material 10 are disposed within the cap and affixed to the inner surface 118 of the bottom wall 114. In this manner, the petals 18 of the material are forced generally upward and interleaved as they emanate from the sidewall 116 of the base 112 and flow outwardly and downward at their terminal ends. It is preferable that the diameter and height of the base 112 bear a dimensional relationship with the diameter of at least the bottom-most sheets of material 10. In one preferred embodiment, the sheet 10 has a diameter of 5 inches, and the base 112 has a diameter of 1.25 inches and a height of 0.5 inches. It is contemplated however that the dimensions be any suitable dimension to permit the petals to sag to the level of the bottom of the base 112.

The base 112 of this embodiment is preferably formed from a vinyl or another suitable polymer. Alternatively, the base 112 in this embodiment may be formed from cardboard, heavy paperstock or any other material suitable for forcing the petals 18 in a generally upward position as they emanate from the sidewall 116 of the base 112. As illustrated in FIG. 5, the base 112 according to this embodiment includes an attaching sheet having a top surface 14 and a bottom surface 16. The top surface 14 of the attaching sheet is attached to the outer surfacer 120 of the base 112, and at least a portion the bottom surface 16 of the attaching sheet is an adhesive material. Again, the bottom surface 16 of the attaching sheet would preferably include a removable backing 24 that could be peeled away to expose the adhesive when desirable to attach the bow 1 to a package surface, wrapping paper, wall surface or the like.

When employing any of the aforementioned bases 12, 112 in accordance with the present invention, the base 12, 112 is typically connected to at least the bottom-most sheet of material 10 by a fastener 26. Preferably, the fastener 26 is a staple, a tack, a rivet or other similar tacking material that is inserted through the center portions 20 of the vertically stacked sheets of material 10 and through the base 12, 112 member to secure the base 12, 112 to all of the sheets of material 10 in their final form. It is contemplated, however, that the fastener 26 may be an adhesive disposed between each of the sheet layers and between the bottom-most sheet and the base 12, 112.

The following description is directed to the method of assembling of the decorative bow 1 in accordance with the present invention. According to the method of the present invention, a plurality of sheets of material 10, each having a top and bottom surface 16, are provided (FIG. 7). Typically, the sheets 10 are die cut blanks having a plurality of slits 28 extending radially outward in a curvilinear fashion. These slits 28 define the plurality of contiguous curvilinear petals 18 discussed herein.

Each of the sheets 10 is arranged vertically such that the petals 18 of each sheet are disposed in an alternating curvilinear direction with respect to the petals 18 of each adjacent sheet. This is may be accomplished by corresponding the top surface 14 of each sheet of material 10 with the top surface 14 of an adjacent sheet of material 10. Likewise, the bottom surface 16 of a sheet of material 10 should be corresponding with the bottom surface 16 of an adjacent sheet of material 10. The fastener 26 is then inserted through the sheets of material 10 and the base 12, 112. Alternatively, each of the plurality of sheets 10 may be separately attached one to the other by fasteners 26 or glue. After the sheets 10 are arranged and connected, the petals 18 of each sheet are interleaved with the of petals 18 of the upwardly adjacent sheet. The interleaved petals 18 are then fluffed to form the body of the bow 1. In its final form, the bow 1 is configured to give the appearance of a chrysanthemum or a flame. When the method is employed in connection with the embodiment of the invention using the base 112, the petals 18 “automatically” fluff as a result of insertion of the sheets 10 into the base 112, and inserting a fastener 26 therethrough.

While the specific embodiments have been illustrated and described, numerous modifications come to mind without significantly departing from the spirit of the invention, and the scope of protection is only limited by the scope of the accompanying Claims.

What is claimed is:

1. A decorative bow comprising:
a plurality of vertically stacked sheets of material, each of the plurality of sheets comprising a top surface, a bottom surface, and a plurality of contiguous curvilinear petals, wherein the petals of each sheet are disposed in an alternating curvilinear direction with respect to the petals of each adjacent sheet and at least some of the petals of each sheet are interleaved with at least some of the petals of an adjacent sheet; and,
a base attached to the bottom surface of the bottom-most sheet of the plurality of vertically stacked sheets.

2. The decorative bow of claim 1, wherein at least some of the plurality of sheets of material are circular.

3. The decorative bow of claim 1, further comprising a fastener securing at least two of the sheets of material together.

4. The decorative bow of claim 1, the base further comprising:
a top surface; and,
a bottom surface, wherein at least the bottom surface of the base comprises an adhesive material.

5. The decorative bow of claim 1, wherein the base is attached to a center portion of a bottom-most sheet.

6. The decorative bow of claim 1, wherein at least one of the vertically stacked sheets of material is selected from the group consisting of foil, Mylar, paper, plastic, fabric, foam, film and combinations thereof.

7. A decorative bow comprising:
a plurality of vertically stacked sheets of material, each of the plurality of sheets comprising a top surface, a bottom surface, and a plurality of contiguous curvilinear petals, wherein the petals of each sheet are disposed in an alternating curvilinear direction with respect to the petals of each adjacent sheet and at least some of the petals of each sheet are interleaved with at least some of the petals of an adjacent sheet; and,
a base attached to the bottom surface of the bottom-most sheet of the plurality of vertically stacked sheets, the base comprising a bottom wall defining a perimeter, at least one sidewall appending upwardly from the perimeter of the bottom wall, an inner surface and an outer surface.

8. The decorative bow of claim 6, wherein at least some of the plurality of sheets of material are circular.

9. The decorative bow of claim 6, further-comprising an attaching sheet attached to the outer surface of the bottom wall of the base.

10. The decorative bow of claim 9, wherein the attaching sheet comprises a top surface and a bottom surface, wherein at least the bottom surface of the attaching sheet is an adhesive material.

11. The decorative bow of claim 6, further comprising a fastener securing at least two of the sheets of material together.

12. The decorative bow of claim 11, wherein the fastener further secures at least one of the plurality of sheets of material to the bottom-most sheet and to the inner surface of the end cap.

13. The decorative bow of claim 6, wherein at least one of the vertically stacked sheets of material is selected from the group consisting of foil, Mylar, paper, plastic, fabric, foam, film and combinations thereof.

14. The decorative bow of claim 6, wherein the outer surface of the base comprises an adhesive material.

15. The decorative bow of claim 6, wherein the base is made from a polymer.

16. A method of assembling a decorative bow comprising the steps of:
providing a plurality of sheets of material, each sheet having a top surface and a bottom surface and a center portion and comprising a plurality of contiguous curvilinear petals;
providing a base comprising a bottom wall defining a perimeter, at least one sidewall appending upwardly from the perimeter of the bottom wall, an inner surface and an outer surface;
arranging each of the sheets vertically such that the petals of each sheet are disposed in an alternating curvilinear direction with respect to the petals of each adjacent sheet;
affixing the sheets to the base by inserting a fastener through a center portion of the arranged sheets and the base, thereby fluffing the bow by causing at least some of the plurality of petals of each sheet to be interleaved with at least some of the plurality of petals of an adjacent sheet.

17. The method of claim 16, further comprising the step of attaching each of the plurality of sheets to an adjacent sheet before the affixing step.

18. A method of assembling a decorative bow comprising the steps of:
providing a plurality of sheets of material, each sheet having a top surface and a bottom surface and comprising a plurality of contiguous curvilinear petals;
arranging each of the sheets vertically such that the petals of each sheet are disposed in an alternating curvilinear direction with respect to the petals of each adjacent sheet;
interleaving at least some of the plurality of petals of each sheet with at least some of the plurality of petals of an adjacent sheet;
attaching the sheets of material one to another; and,
fluffing the interleaved petals of the sheets of material.

19. The method of claim 18, further comprising the step of attaching each of the plurality of sheets to an adjacent sheet before the interleaving step.

20. The method of claim 18, further comprising the step of attaching a base to a bottom-most sheet of the plurality of sheets of material.
